(19) United States
(12) Patent Application Publication
(10) Pub. No.: US 2020/0120218 A1
(43) Pub. Date: Apr. 16, 2020

(54) IMAGE FORMING APPARATUS, A NON-TRANSITORY COMPUTER-READABLE RECORDING MEDIUM STORING CONTROL PROGRAM, AND CONTROL METHOD

(71) Applicant: SHARP KABUSHIKI KAISHA, Osaka (JP)

(72) Inventor: MASAKI INUI, Sakai City (JP)

(21) Appl. No.: 16/595,850

(22) Filed: Oct. 8, 2019

(30) Foreign Application Priority Data
Oct. 11, 2018 (JP) 2018-192308

(51) Int. Cl. H04N 1/00; H04L 12/58; G08B 13/22; H04L 12/24

(52) U.S. Cl. CPC H04N 1/0048; H04L 51/22; H04N 1/00891; H04L 41/0686; G08B 13/22

(57) ABSTRACT

An image forming apparatus includes a main CPU. The main CPU detects whether or not a commercial power supply has been shut off while operating in a warning mode which, in response to detecting an intruder, alerts a surrounding person and/or a specified person that the intruder was detected. If the commercial power supply has been shut off, the surroundings are alerted in the form of audio that the commercial power supply has been shut off, and the alert is also issued by transmission of an email addressed to an administrator.

### BACKGROUND

### Field of the Invention

The present invention relates to an image forming apparatus, a non-transitory computer-readable recording storing control program, and a control method. In particular, for example, the present invention relates to an image forming apparatus, a non-transitory computer-readable recoding medium storing control program, and a control method that alert that an intruder has been detected in a warning mode.

### Description of the Background Art

An example of a related technique of this type is disclosed in Japanese Laid-Open Patent Application Publication No. 2017-97774. The hardware device disclosed in Japanese Laid-Open Patent Application Publication No. 2017-97774 includes a built-in battery. If a commercial power supply is shut off while in a theft prevention mode, the hardware device operates the built-in battery as a power supply to execute alert processing, such as the sounding of an alarm.

### SUMMARY

However, conventional image forming apparatuses usually do not include a battery. Therefore, if a commercial power supply is shut off while in a warning mode, such as a theft prevention mode as described above for the background art, alert processing that alerts that the power supply has been shut off cannot be executed. Furthermore, it is unrealistic to provide a battery just for executing the alert processing.

The present invention is directed to provide a new image forming apparatus, control program, and control method.

The present invention is also directed to provide an image forming apparatus, a control program, and a control method which are capable of alerting that a commercial power supply and a network have been shut off while in a warning mode without providing a battery for issuing the alert.

A first aspect of the invention is an image forming apparatus provided with a warning mode that, in response to detecting an intruder, alerts a surrounding person and/or a specified person that the intruder has been detected, the image forming apparatus including a power supply determination device that determines whether or not a main power supply has been shut off when the warning mode is set, and a first alert device that alerts the surrounding person and/or the specified person with a message indicating that the main power supply has been shut off, in response to the power supply determination device determining that the main power supply has been shut off.

A second aspect of the invention is the image forming apparatus according to the first aspect, further including a network determination device that determines whether or not a network has been shut off when the warning mode is set, and a second alert device that alerts the surrounding person with a message indicating that the network has been shut off, in response to the network determination device determining that the network has been shut off.

A third aspect of the invention is the image forming apparatus according to second aspect, further including a reservation execution device that transmits, while in the warning mode, a reservation command to a mail server for reserving transmission of an email that includes a message indicating that the network has been shut off, a reservation releasing device that transmits a release command to the mail server for releasing the reservation of the email transmission before a predetermined time period elapses following the transmission of the reservation command to the mail server by the reservation execution device, and an execution device that causes repeated execution of the transmission of the reservation command by the reservation execution device and the transmission of the release command by the reservation releasing device.

A fourth aspect of the invention is a non-transitory computer-readable recording medium storing control program executed by an image forming apparatus provided with a warning mode that, in response to detecting an intruder, alerts a surrounding person and/or a specified person that the intruder has been detected, the control program causing a processor of the image forming apparatus to execute determining whether or not a main power supply has been shut off when the warning mode is set, and alerting the surrounding person and/or the specified person with a message indicating that the main power supply has been shut off, in response to determining that the main power supply has been shut off.

A fifth aspect of the invention is a control method of an image forming apparatus provided with a warning mode that, in response to detecting an intruder, alerts a surrounding person and/or a specified person that the intruder has been detected, the method including (a) determining whether or not a main power supply has been shut off when the warning mode is set, and (b) alerting the surrounding person and/or the specified person with a message indicating that the main power supply has been shut off, in response to determining in (a) that the main power supply has been shut off.

According to the present invention, even when a commercial power supply and a network have been shut off while in a warning mode, it is possible to alert that the shut off has occurred without providing a battery for issuing the alert.

The object above, other objects, features and advantages of the present invention will become more apparent from the detailed description of the following embodiments given with reference to the drawings.

### BRIEF DESCRIPTION OF THE DRAWINGS

FIG. 1 is a diagram showing an example of an information processing system.

FIG. 2 is a block diagram showing an example of an electrical configuration of the image forming apparatus shown in FIG. 1.

FIG. 3 is a block diagram showing an example of a configuration of a power supply unit of the image forming apparatus shown in FIG. 1.

FIG. 4 is a diagram showing a example of a configuration of a main power supply shown in FIG. 3.

FIG. 5A is a waveform diagram showing a voltage waveform of a commercial power supply.

FIG. 5B is a waveform diagram showing a full-wave (FW) signal waveform.

FIG. 6 is a diagram showing an example of a memory map of a random access memory (RAM) of the image forming apparatus shown in FIG. 2.

FIG. 7 is a flowchart showing part of an example of control processing performed by the main central processing unit (CPU) of the image forming apparatus shown in FIG. 2.

FIG. 8 is a flowchart that follows on from FIG. 7, and shows another part of an example of control processing performed by the main CPU of the image forming apparatus shown in FIG. 2.

FIG. 9 is a flowchart showing an example of reservation processing performed by the main CPU of an image forming apparatus according to a second embodiment, and an example of reservation transmission processing performed by a CPU of a mail server.

### DETAILED DESCRIPTION

Hereunder, embodiments of the present invention will be described in detail with reference to the accompanying drawings.

### First Embodiment

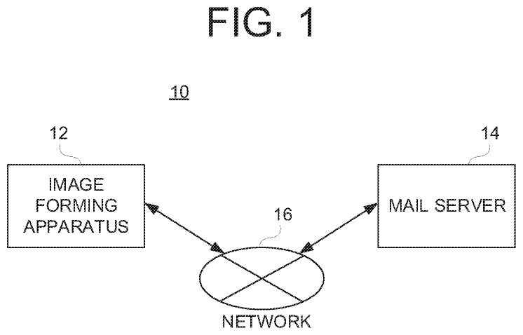

FIG. 1 is a diagram showing an example of a configuration of an information processing system 10 according to a first embodiment. As shown in FIG. 1, the information processing system 10 includes an image forming apparatus 12 and a mail server 14. The image forming apparatus 12 is connected to the mail server 14 via a network 16, such as a LAN and/or the Internet.

In the first embodiment, the image forming apparatus 12 is a multifunction peripheral (MFP) which includes a copy function, a printer function, a scanner function, a facsimile function, and the like. However, the present embodiment may be applied to other types of image forming apparatuses, such as copiers (copy machines), printing devices (printers), and facsimiles.

The mail server 14 is a general-purpose mail server which, although not shown, is provided with various components including a processor, a RAM, and a communication unit.

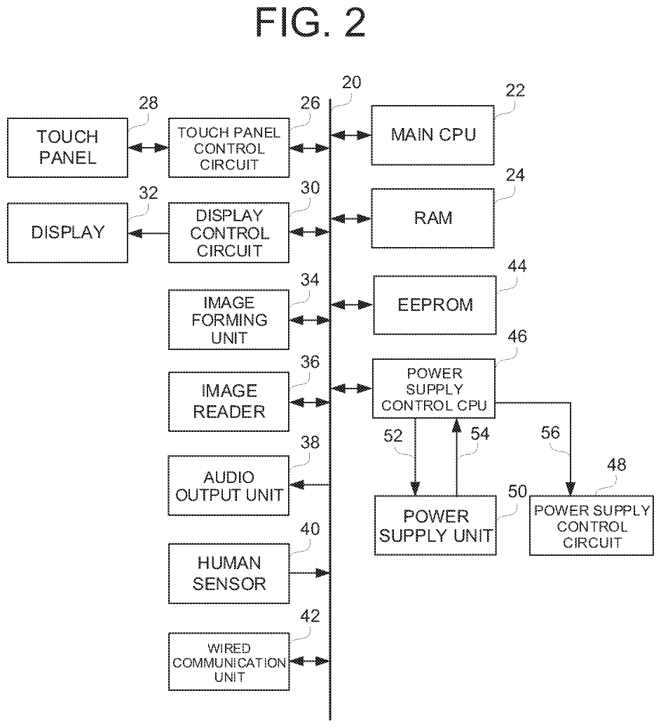

FIG. 2 is a block diagram showing an electrical configuration of the image forting apparatus 12 shown in FIG. 1. As shown in FIG. 2, the image forming apparatus 12 includes a main CPU 22. The main CPU 22 is connected via a bus 20 to a RAM 24, a touch panel control circuit 26, a display control circuit 30, an image forming unit 34, an image reader 36, an audio output unit 38, a human sensor 40, a wired communication unit 42, an electrically erasable programmable read-only memory (EEPROM) 44, and a power supply control CPU 46. Furthermore, the image forming apparatus 12 includes a touch panel 28, a display 32, a power supply control circuit 48, and a power supply unit 50. The touch panel 28 is connected to the touch panel control circuit 26, and the display 32 is connected to the display control circuit 30. Furthermore, as described in detail below, the power supply unit 50 is connected to the power supply control CPU 46 via a signal line 52 and a signal line 54. The power supply control circuit 48 is connected to the power supply control CPU 46 via a signal line 56.

The main CPU 22 performs the overall control of the image forming apparatus 12. The RAM 24 is used as a work area and a buffer area of the main CPU 22 and the power supply control CPU 46.

The touch panel control circuit 26 applies the necessary voltage and the like to the touch panel 28. The touch panel control circuit 26 also detects touch operations or touch inputs inside a touch effective area of the touch panel 28, and outputs coordinate data of the touch positions to the main CPU 22.

The touch panel 28 is provided on the display surface of the display 32. An arbitrary type of touch panel, such as an electrostatic capacitance-type, electromagnetic induction-type, resistance film-type, or infrared-type, may be used as the touch panel 28. Furthermore, a touch panel display may be used, in which the touch panel 28 and the display 32 are integrated.

The display control circuit 30 includes a graphics processing unit (GPU), a video random access memory (VRAM), and the like. The GPU, under instructions from the main CPU 22, uses image generation data 404b stored in the RAM 24 to generate display image data in the VRAM for displaying various screens on the display 32, and outputs the generated display image data to the display 32.

The display 32 is a general-purpose display device, such as an liquid crystal display (LCD) or electro-luminescence (EL) display.

The image forming unit 34 includes a photosensitive drum, a charging device, an exposure device, a developing device, a transfer device, a fixing device and the like, and forms an image on a paper sheet using a dry electrophotographic method. Image data read by the image reader 36 or image data sent from an external information processing device or the like is used as the image data to be formed on the paper surface. Furthermore, the recording medium is not limited to a sheet made of paper.

The image reader 36 includes a light source, a plurality of mirrors, an imaging lens, a line sensor, and the like. The image reader 36 guides reflected light from the surface of a document to the imaging lens by means of the plurality of mirrors. Then, the reflected light is imaged on a light-receiving element of the line sensor by the imaging lens. The line sensor detects the luminance or the chromaticity of the reflected light imaged on the light-receiving element, and generates read image data based on the image of the document surface. Furthermore, a complementary metal oxide semiconductor (CMOS), a charged coupled device (CCD), or the like is used for the line sensor.

The audio output unit 38 includes a speaker, a digital to analog (D/A) converter, an amplifier, and the like. The D/A converter and the amplifier convert a digital audio signal into an analog signal, and output the signal to a speaker after amplification. The speaker receives the analog audio signal and outputs the audio.

The human sensor 40 is a sensor for determining whether or not a person exists in front (on the front side) of the image forming apparatus 12. A pyroelectric sensor (infrared sensor), an optical distance measuring sensor, an ultrasonic sensor, or the like is used as the human sensor 40. A semicircular section in front of the image forming apparatus 12 is set as a detection area, whose radius is a predetermined distance (for example, 3 to 5 m) which is shorter than the distance (maximum distance) that can be detected by the human sensor 40, is set as a detection area. A person object inside the detection area is detected based on the detection result of the human sensor 40.

The wired communication unit 42 has an RJ-45 type connector that supports 10BASE-T and 100BASE-TX of the Institute of Electrical Electronics Engineers (IEEE) 802.3 standard, a wired communication circuit for connecting to the network 16, and a link pulse detection circuit for detecting a shut-off of the network 16.

The wired communication circuit performs communications via the network 16 according to instructions by the main CPU 22. As an example, the wired communication unit 42 transmits and receives data based on a wired communication method that complies with a communication standard such as Ethernet (registered trademark). On the other hand, the link pulse detection circuit detects link pulse signals transmitted at a constant cycle (25 to 50 ms) from a device on the network 16, which is connected to the image forming apparatus 12 via a connector and a local area network (LAN) cable and the like.

The EEPROM 44 is a non-volatile memory which stores various information set by the user, and various information such as status information of the image forming apparatus 12. However, other types of non-volatile memory may be used, such as a flash memory or a hard disk drive (HDD).

The image configuration of the image forming apparatus 12 shown in FIG. 2 is merely an example, and it is not necessarily limited to this.

The image forming apparatus 12 described above is provided with a warning mode. The warning mode is a mode in which processing that alerts that an intruder has been detected (hereinafter, referred to as “alert processing”) is executed if an intruder is detected in a preset time period, and has object of preventing the process unit, the developing unit, and consumable items such as toner and recording paper included in the image forming apparatus 12 from being stolen. As an example, if the image forming apparatus 12 is installed in an office, the time period (that is to say, the start time and the end time of the warning mode) is set from the end of business hours until the start of the next business hours. However, the warning mode may also be started or ended by a specified person such as an administrator.

In the warning mode, when a person or object is detected inside the detection area based on the output of the human sensor 40, the image forming apparatus 12 executes alert processing, which outputs a message indicating that an intruder was detected, in the form of audio from the audio output unit 38 (speaker), and also by transmitting an email to the computer of a specified person such as an administrator.

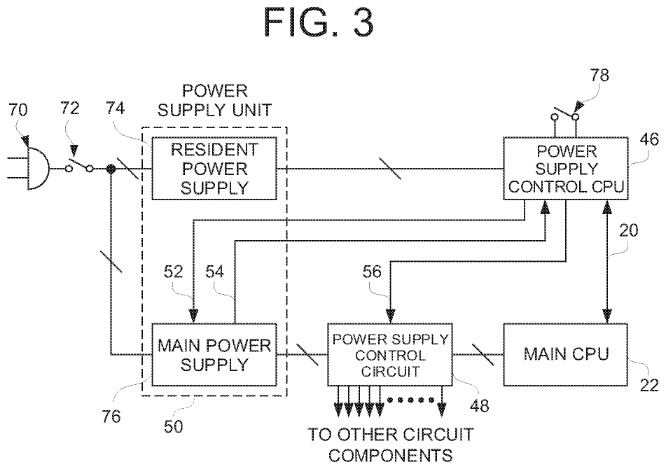

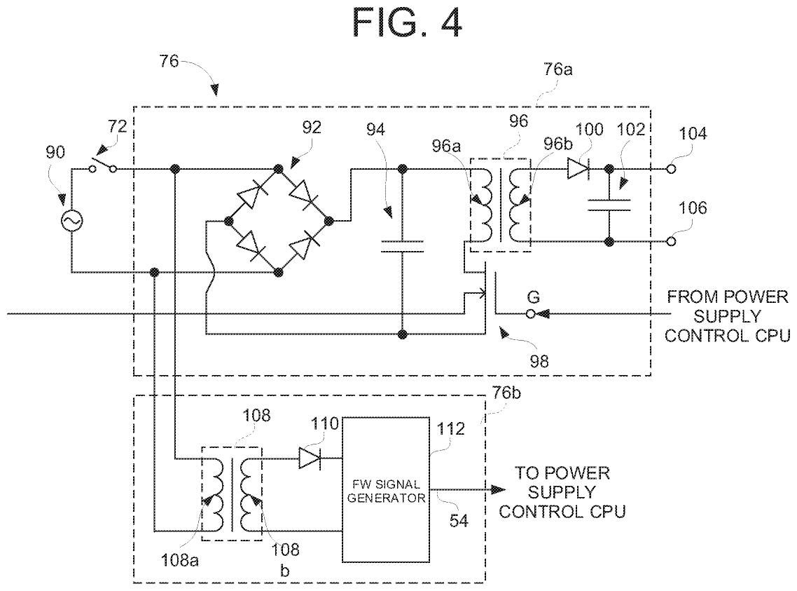

However, while in the warning mode, if the commercial power supply 90 is shut off as a result of a breaker trip, a main power supply switch 72 (see FIG. 3 and FIG. 4) of the image forming apparatus 12 being turned off, or a power cable of the image forming apparatus 12 being disconnected, that is to say, if the main power supply is turned off, the image forming apparatus 12 is unable to execute alert processing as described above, and the risk of consumable items being stolen increases. If a battery is provided in the image forming apparatus 12 to avoid such risks, alert processing as described above can be executed by using the battery as a power supply, even if the commercial power supply 90 is shut off. However, it is unrealistic to provide a battery just for performing the alert processing.

Furthermore, in the image forming apparatus 12, if the network 16 is shut off due to a local area network (LAN) cable being disconnected and the like, an email including a message indicating that an intruder was detected cannot be transmitted to the mail server or a destination computer, even if the alert processing is executed. However, because an alert function that alerts that the network 16 is shut off is not provided, it is not possible to issue an alert in the case where only the network 16 is shut off.

In order to avoid such an inconvenience, in the first embodiment, it is possible to execute alert processing that alerts that the commercial power supply 90 has been shut off, or that the network 16 has been shut off, without providing a battery for issuing the alert.

FIG. 3 is a block diagram showing a configuration of the power supply unit 50 of the image forming apparatus 12 shown in FIG. 1. Note that, in FIG. 3, a hatched line indicates an electrical wire, and a non-hatched line indicates a signal lines or a bus.

As shown in FIG. 3, the power supply unit 50 includes a resident power supply 74 and a main power supply 76. The resident power supply 74 and the main power supply 76 are connected by electrical wires to the outlet plug 70 via the main power supply switch 72. Electrical power alternating current voltage) is supplied from the commercial power supply 90 (see FIG. 4) to the power supply unit 50 as a result of the outlet plug 70 being inserted into a wall socket or the like. Furthermore, the resident power supply 74 is connected by an electrical wire to the power supply control CPU 46. The main power supply 76 is connected by electrical wires to the respective components and the main CPU 22 via the pourer supply control circuit 48.

Moreover, the power supply control CPU 46 is connected to the main power supply 76 via the signal line 52 and the signal line 54, and is connected to the power supply control circuit 48 via the signal line 56. Also, as described above, the power supply control CPU 46 is connected to the main CPU 22 via the bus 20. Although not shown in FIG. 2, a power button 78 is connected to the power supply control CPU 46. The power supply control CPU 46 is operated and stopped by the on/off of the power button 78, thereby controlling the main power supply 76.

The resident power supply 74 is a switching power supply, and applies a direct current voltage to the power supply control CPU 46 after stepping-down and rectifying the alternating current voltage supplied from the commercial power supply 90. Similarly to the resident power supply 74, the main power supply 76 is a switching power supply, and applies a direct current voltage to the power supply control circuit 48 after stepping-down and rectifying the alternating current voltage supplied from the commercial power supply 90. The power supply control circuit 48 turns on/off the power supply to the main CPU 22 and the other circuit components according to instructions from the power supply control CPU 46. Note that the power supply control circuit 48 steps-up or steps-down the direct current voltage applied from the main power supply 76 as necessary.

Note that, in the first embodiment, the main power supply 76 includes, in addition to a switching power supply circuit 76a, a circuit 76b for detecting that the commercial power supply 90 has been shut off.

Furthermore, in the first embodiment, the switching power supply circuit of the resident power supply 74 is identical to the circuit 76a (see FIG. 4) described below. However, the switching of a field effect transistor (FET) (switching element) of the resident power supply 74 is controlled by the on/off of the main power supply switch 72 rather than the power supply control CPU 46.

FIG. 4 is a diagram shoving an example of a configuration of the main power supply 76 shown in FIG. 3. As shown in FIG. 4, the main power supply 76 includes the circuit 76a and the circuit 76b as described above. The circuit 76a includes a transformer 96. One end of a coil 96a provided on the input side (primary side) of the transformer 96 is connected to the commercial power supply 90 via a bridge diode 92. Note that, in FIG. 4, the outlet plug 70 is omitted. Moreover, the main power supply switch 72 described above is provided on one of the power supply lines between the commercial power supply 90 and the bridge diode 92.

Also, the circuit 76a includes an electrolytic capacitor (hereinafter, simply referred to as “capacitor”) 94. One end of the capacitor 94 is connected to a connection point between the positive output end of the bridge diode 92 and the primary side coil 96a of the tray transformer 96. The other end of the coil 96a is connected to the negative output end of the bridge diode 92 via an FET 98. The other end of the capacitor 94 is connected to a connection point between the bridge diode 92 and the FET 98.

Note that the commercial power supply 90 is connected to the input end of the bridge diode 92. Furthermore, the drain of the FET 98 is connected to the coil 96a, the source is connected to the bridge diode 92, and the gate is connected to the power supply control CPU 46 via the signal line 52.

One end of a coil 96b provided on the output side (secondary side) of the transformer 96 is connected to the anode of a diode 100. The cathode of the diode 100 is connected to an output terminal 104. One end of a capacitor 102 is connected to a connection point between the diode 100 and the output terminal 104. The other end of the capacitor 102 is connected to a connection point between the other end of the coil 96b and the output terminal 106. The output terminal 104 and the output terminal 106 are connected to the power supply control circuit 48.

Although not shown, the output terminal 104 is connected to the power supply control CPU 46 via a feedback circuit (not shown).

Furthermore, although the FET 98 is used as the switching element in the first embodiment, a transistor may also be used.

In the circuit 76a, when the main power switch 72 is turned on, the alternating current from the commercial power supply 90 is full-wave rectified by the bridge diode 92, smoothed by the capacitor 94, and then converted into a direct current. The FET 98 undergoes switching (repeatedly turns on/off) in response to a control signal from the power supply control CPU 46, and the direct current is converted into a high-frequency current in the primary side coil 96a of the transformer 96. Therefore, an electromotive force is generated in the primary side coil 96a of the transformer 96. Then, energy (alternating current) is transmitted to the secondary side coil 96b of the transformer 96. That is to say, an electromotive force is induced in the secondary side coil 96b. Note that, in the coil 96b, an electromotive force (alternating current voltage) is generated that corresponds to a turn ratio of the coil 96a to the coil 96b. The alternating current flowing through the coil 96b is rectified by the diode 100, smoothed by the capacitor 102, and direct current is output from the output terminals 104 and 106.

Although not shown, the voltage value of the direct current voltage applied between the output terminal 104 and the output terminal 106 is detected by a feedback circuit (not shown) and is fed back to the power supply control CPU 46. The power supply control CPU 46 controls the length of the on (or off) period of the FET 98 based on the voltage value that is fed back.

Furthermore, the circuit 76b includes a transformer 108, and a primary side coil 108a of the transformer 108 is connected to the commercial power supply 90. The aspect in which the outlet plug 70 is omitted, and the aspect in which the main power supply switch 72 is provided are the same as the case of the circuit 76a.

One end of a secondary side coil 108b of the transformer 108 is connected to the anode of a diode 110. The cathode of the diode 110 is connected to an FW signal generator 112. Furthermore, the other end of the coil 108b is connected to the FW signal generator 112. The output end of the FW signal generator 112 is connected to the power supply control CPU 46 via the signal line 54.

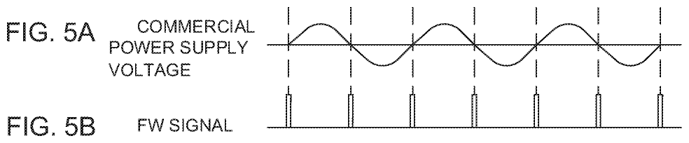

Here, the FW signal generator 112 is a circuit for generating an FW signal based on the electric power supplied from the commercial power supply 90. Although a detailed description is omitted, the FW signal generator 112 generates an FW signal having a pulse waveform that becomes a high level at the zero crossing of the alternating current voltage supplied from the commercial power supply 90. As shown in FIG. 5A, the amplitude of the waveform of the alternating current voltage of the commercial power supply 90 changes at a predetermined frequency (50 Hz or 60 Hz in Japan). The commercial power supply 90 is rectified by the transformer 108 and the diode 110, and is converted into a square wave (direct current voltage) in which the positive side of the alternating current voltage becomes a high level. The FW signal generator 112 generates a pulse waveform, that is to say, an FW signal that becomes a high level at the rising edge where the square wave changes from the low level to the high level, and at the falling edge where the square wave changes from the high level to the low level. In other words, an FW signal as shown in FIG. 5B is generated. The FW signal generator 112 outputs the generated FW signal to the power supply control CPU 46.

Therefore, when the commercial power supply 90 is shut off, a low-level FW signal without a pulse is generated. In the first embodiment, when the power supply control CPU 46 detects a low level FW signal for at least a first predetermined time period (for example, approximately two cycles of the alternating current voltage waveform of the commercial power supply 90), the power supply control CPU 46 detects that the commercial power supply 90 has been shut off, and notifies the main CPU 22 that the commercial power supply 90 has been shut off. Therefore, the main CPU 22 outputs a message indicating that the commercial power supply 90 has been shut off, in the form of audio from the audio output unit 38, and also by transmitting an email to the computer of an administrator or the like via the wired communication unit 42. That is to say, alert processing that indicates that the commercial power supply 90 has been shut off is executed.

Because the switching of the FET 98 is continued even if the commercial power supply 90 is shut off, the direct current voltage output from the main power supply 76 gradually decreases due to the electric charge held by the capacitor 102. Therefore, the alert processing described above is executed before the direct current power voltage output from the main power supply 76 decreases to an extent that the circuit components necessary for executing the alert processing, such as the main CPU 22, the RAM 24, the audio output unit 38, the wired communication unit 42, and the power supply control CPU 46, are unable to be operated.

Furthermore, the image forming apparatus 1 to the first embodiment is connected to the network 16 via a LAN cable. In other words, the image forming apparatus 12 is communicably connected to other devices such as a computer on the network 16. The image forming apparatus 12 and the devices on the network 16 each transmit link pulse signals for confirming a physical connection to each other at a fixed cycle (25 to 50 ms). As a result of receiving (or detecting) the link pulse signals from each other, it is confirmed that the physical connection is established. Therefore, if the main CPU 22 is unable to detect a link pulse signal within the fixed cycle, the main CPU 22 determines that the network 16 has been shut off, and executes alert processing that alerts that the network 16 has been shut off. In the first embodiment, a message indicating that the network 16 has been shut off is output in the form of audio from the audio output unit 38. That is to say, alert processing that indicates that the network 16 has been shut off is executed.

In the first embodiment, the alert processing issues the alert the form of an audio message, or in the form of both audio and an email message. However, a warning lamp (not shown) may be turned on and/or made to blink instead of using audio, or in addition to using audio. A message may also be displayed on the display 32 instead of turning on the warning lamp or the like. However, this is not an appropriate form of alert processing because the power consumption becomes large when the commercial power supply 90 is shut off.

As described above, the image forming apparatus 12 according to the first embodiment not only executes alert processing which alerts that an intruder has been detected while in a warning mode, but also executes alert processing that alerts that the commercial power supply 90 has been shut off, and alert processing that alerts that the network 16 has been shut off.

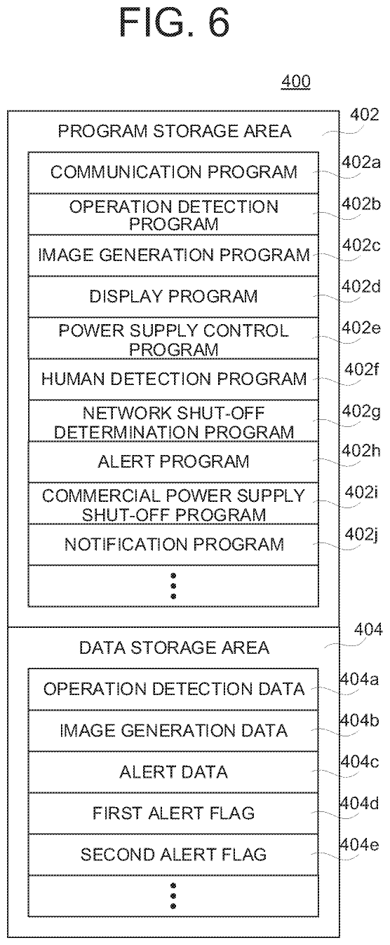

FIG. 6 is a diagram showing an example of a memory map 400 of the RAM 24 of the image forming apparatus 12 shown in FIG. 2. As shown in FIG. 6, the RAM 24 includes a program storage area 402 and a data storage area 404. The program storage area 402 of the RAM 24 stores control programs of the image forming apparatus 12. The control processing programs include a communication program 402a, an operation detection program 402b, an image processing program 402c, a display program 402d, a power supply control program 402e, a human detection program 402f, a network shut-off determination program 402g, a alert program 402h, a commercial power supply shut-off determination program 402i, and an notification program 402j.

Note that the commercial power supply shut-off determination program 402i and the notification program 402j are programs executed by the power supply control CPU 46. Further, the other programs 402a to 402h are programs executed by the main CPU 22.

The communication program 402a is a program for determining the connection state with the network 16, and for performing data transmission and reception by controlling the wired communication unit 42 if communication is possible.

The operation detection program 402b is a program for detecting operation data corresponding to operations with respect to the operation units of the image forming apparatus 12. When the touch panel 28 is touched (or operated), the main CPU 22 acquires touch coordinate data output from the touch panel 28 as operation data 404a according to the operation detection program 402b, and stores the data in a buffer. Inputs with respect to hardware buttons such as the power button 78 are similarly acquired (or detected).

The image generation program 402c is a program for generating image data for displaying various display images on the display 32 using the image generation data 404b described below.

The display program 402d is a program for displaying, on the display 32, the images corresponding to the display age data generated according to the image generation program 402c.

The power supply control program 402e is a program for starting/stopping the supply of power to each of the components.

The human detection program 402f is a program for determining whether or not a person or object exists inside a detection area based on a detection result from the human sensor 40.

The network shut-off determination program 402g is a program for determining whether or not the network 16 has been shut off.

The alert program 402h is a program for using alert data 404c to issue an alert, in the form of audio, or in the form of both audio and an email, that an intruder was detected, that the commercial power supply 90 was shut off, or that the network 16 was shut off.

The commercial power supply shut-off determination program 402i is a program for determining whether or not the commercial power supply 90 has been shut off.

The notification program 402j is a program for notifying the main CPU 22 that the commercial power supply 90 was shut off, if it is determined that the commercial power supply 90 was shut off.

The data storage area 404 stores operation data 404a, image generation data 404b, and alert data 404c.

The operation data 404a is operation data detected according to the operation detection program 402b, and is stored according to a time series. The operation data 404a is deleted after being used in processing by the main CPU 22.

The image generation data 404b is data that includes polygon data and texture data for generating display image data, which corresponds to the display screens which are displayed on the display 32.

The alert data 404c is data which is used for alert processing. In the first embodiment, this includes synthetic audio data for issuing an alert in the form of audio, and text data for issuing an alert in the form of an email.

Furthermore, the data storage area 404 is provided a first alert flag 404d and a second alert flag 404e.

The first alert flag 404d is a flag for determining whether or not alert processing that alerts that the network 16 has been shut off has been executed. The first alert flag 404d is turned on when alert processing that alerts that the network 16 has been shut off has been executed, and is turned off when the alert processing has not been executed.

The second alert flag 404e is a or determining whether or not alert processing that alerts that an intruder has been detected has been executed. The second alert flag 404e is turned on when alert processing that alerts that an intruder has been detected has been executed, and is turned off when the alert processing has not been executed.

Although not shown, the data storage area 404 stores other data necessary for executing the control programs, and is also provided with other flags and counters (timers) necessary for executing the control programs.

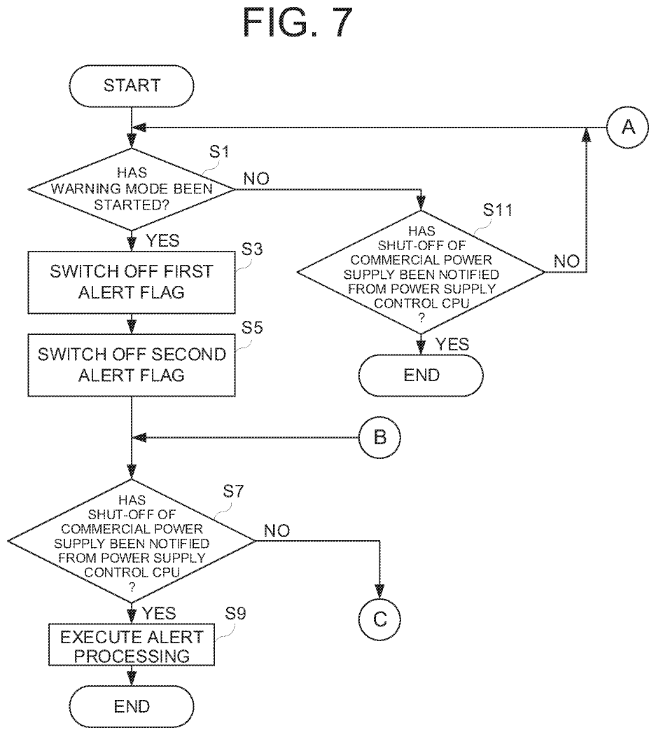

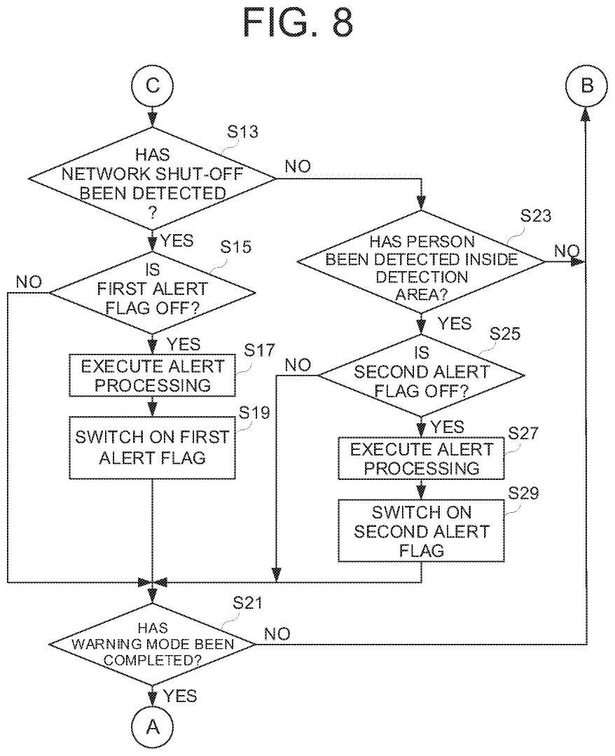

FIGS. 7 and 8 are flowcharts showing an example of control processing performed by the main CPU 22 of the image forming apparatus 12 shown in FIG. 2. Note that, when the control processing is started, the main power supply switch 72 and the power button 78 are turned on, electrical power is supplied from the commercial power supply 90 to the image forming apparatus 12, and the image forming apparatus 12 is in a usable state.

As shown in FIG. 7, when the main CPU 22 starts the control processing, the main CPU 22 determines in step S1 whether or not to start the warning mode. In step S1, the main CPU 22 determines whether or not the start of the warning mode has been instructed by a user operation, or whether or not a start time of the warning mode has arrived. Note that the main CPU 22 acquires the current time from a clock circuit such as an RTC. It is determined whether or not the current time matches the start time of the warning mode.

If the result of step S1 is “NO”, that is to say, if the warning mode is not to be started, the process proceeds to step S11. On the other hand, if the result of step S1 is “YES”, that is to say, if the warning mode is to be started, the first alert flag 404d is turned off in step S3, and the second alert flag 404e is turned off in the following step S5.

In the following step S7, it is determined whether or not it has been notified that the commercial power supply 90 has been shut off from the power supply control CPU 46. Although not shown, in parallel with the control processing performed by the main CPU 22, the power supply control CPU 46 determines whether or not the commercial power supply 90 has been shut off based on an FW signal, and also executes processing for notifying the main CPU 22 that the commercial power supply 90 has been shut off, if the commercial power supply 90 has been shut off.

If the result of step S7 is “NO”, that is to say, if it is determined that there is no notification that the commercial power supply 90 has been shut off from the power supply control CPU 46, the process proceeds to step S13 in FIG. 8. If the result of step S7 is “YES”, that is to say, if it is determined that there is a notification that the commercial power supply 90 has been shut off from the power supply control CPU 46, alert processing that notifies that the commercial power supply 90 has been shut off is executed in step S9, and the control processing ends.

Note that, in step S9, the main CPU 22 outputs a message indicating that the commercial power supply 90 has been shut off from the audio output unit 38 in the form of audio, and also transmits an email using the wired communication unit 42. At this time, synthetic audio data of the audio corresponding to the message indicating that the commercial power supply 90 has been shut off, the text data corresponding to the message, and an email address are acquired from the alert data 404c. This is identical in the other alert processing steps (S17 and S27) described below.

Furthermore, in a similar manner to step S7, it is determined in step S11 whether or not it has been notified that the commercial power supply 90 has been shut off from the power supply control CPU 46. If the result of step S11 is “NO”, the process returns to step S1. On the other hand, if the result of step S11 is “YES”, the control processing ends.

In step S13 in FIG. 8, it is determined whether or not it is detected that the network 16 has been shut off. If the result of step S13 is “NO”, that is to say, if it is not detected that the network 16 has been shut off, the process proceeds to step S23. On the other hand, if the result of step S13 is “YES”, that is to say, if it is detected that the network 16 has been shut off, in step S15 it is determined whether or not the first alert flag 404d is off.

If the result of step S15 is “NO”, that is to say, the first alert flag 404d is on, the process proceeds to step S21. On the other hand, if the result of step S15 is “YES”, that is to say, if the first alert flag 404d is off, alert processing that alerts that the network 16 has been shut off is executed in step S17, and the first alert flag 404d is turned on in step S19. Then, the process proceeds to step S21.

Next, in step S21, it is determined whether or not the warning mode is to be ended. In step S21, the main CPU 22 determines whether or not an end of the warning mode has been instructed by a user operation, or whether or not the end time of the warning mode has arrived. Note that the main CPU 22 acquires the current time from a clock circuit such as an RTC. It is determined whether or not the current time matches the end time of the warning mode.

If the result of step S21 is “NO”, that is to say, it the warning mode is not to be ended, the process returns to step S7 in FIG. 7. On the other hand, if the result of step S21 is “YES” that is to say, if the warning mode is to be ended, the process returns to step S1 in FIG. 7.

Furthermore, in step S23, it is determined whether or not a person (that is to say, an intruder) was detected inside the detection area. Here, the main CPU 22 determines whether or not a person (or object) was detected inside the detection area set with respect to the image forming apparatus 12 based on the output of the human sensor 40.

If the result of step S23 is “NO”, that is to say, if a person was not detected inside the detection area, the process returns to step S7. On the other hand, if the result of step S23 is “YES”, that is to say, if a person was detected inside the detection area, it is determined in the following step S25 whether or not the second alert flag 404e is off.

If the result of step S25 is “NO”, that is to say, the second alert flag 404e is on, the process proceeds to step S21. On the other hand, if the result of step S25 is “YES”, that is to say, if the second alert flag 404e is off, alert processing that alerts that an intruder was detected is executed in step S27, and the second alert flag 404e is turned on in step S29. Then, the process proceeds to step S21.

According to the first embodiment, it is possible to execute, while in the warning mode, alert processing that alerts that the commercial power supply 90 has been shut off, and alert processing that alerts that the network 16 has been shut off without providing a battery for issuing the alert.

In the first embodiment, the alert processing that alerts that the network 16 has been shut off, and the alert processing that alerts that an intruder was detected, are set such that each is performed a single time. However, it is not necessary for the alert frequency while in the warning mode to be limited to a single time. For example, rather than providing the first alert flag 404d and the second alert flag 404e, the alert processing may be repeated over a second predetermined time period (for example, for approximately several seconds to several minutes) or repeated an unlimited number of times. Furthermore, for example, the first alert flag 404d and the second alert flag 404e may be turned off after a third predetermined time period (for example, several seconds to several tens of minutes) elapses after the first alert flag 404d and the second alert flag 404e are turned on.

In addition, in the first embodiment, the image forming apparatus 12 includes the main CPU 22 and the power supply control CPU 46. However, it is not limited to this. The processing executed by both the main CPU 22 and the power supply control CPU 46 may be achieved by providing a single CPU with a high processing power.

Furthermore, although the description was omitted in the first embodiment, if the main power supply of the image forming apparatus 12 is turned off while the image forming apparatus 12 is in a usable state (that is to say, is set to the normal mode), data containing important information such as copy quantity data (or billing data) is stored (or saved) to the EEPROM 44 from the RAM 24. Note that, as described above, when the main power supply is turned off while in the warning mode, alert processing is executed that alerts that the commercial power supply 90 has been shut off. Therefore, the data containing important information described above is saved to the EEPROM 44 when the warning mode is started. This is because printing is not executed while in the warning mode. Specifically, the processing that saves the data containing important information is executed upon determining that the result of step S1 in FIG. 7 is “YES” until execution of the processing of step S7, and is also performed upon determining that the result of step S11 is “YES” until the end of the control processing.

### Second Embodiment

In the image forming apparatus 12 according to a second embodiment, it is possible to issue an alert in the form of an email to an administrator, even when the network 16 has been shut off. Otherwise, the device is the same as that of the first embodiment, and a duplicate description of such content is omitted.

In the second embodiment, when the warning mode starts, the image forming apparatus 12 transmits an email transmission reservation command (hereinafter, referred to as “reservation command”) to the mail server 14 (or a mail server other than the mail server 14) via the network 16. Upon receiving the reservation command, the mail server 14 reserves an email transmission to the personal computer (PC) of an administrator such that the transmission takes place after a fourth predetermined time (for example, from several minutes to several tens of minutes) has elapsed. The email is an email for alerting that the network 16 has been shut off. Furthermore, after reserving the email transmission, the image forming apparatus 12 transmits a command that releases the email transmission reservation (hereinafter, referred to as “release command”) to the mail server 14 after a shorter time period (fifth predetermined time period) than the fourth predetermined time period has elapsed, and cancels the email transmission reservation. In the second embodiment, the image forming apparatus 12 repeatedly executes transmission of the reservation command and the release command in the warning mode. Moreover, in the second embodiment, the fifth predetermined time period is set to a time period which is several seconds to several tens of seconds shorter than the fourth predetermined time period. That is to say, the fifth predetermined time period is set such that the release command is transmitted to the mail server 14 before the reserved email is transmitted by the mail server 14.

On the other hand, when the mail server 14 receives the reservation command, the mail server 14 counts up to the fourth predetermined time period. If the release command is not received before the fourth predetermined time period elapses, it determines that the network 16 has been shut off for some reason. In this case the reserved email is transmitted. Therefore, in the second embodiment, it is also possible to alert an administrator that the network 16 has been shut off. Note that if the mail server 14 receives the release command before the fourth predetermined time period has elapsed, the mail server 14 releases the email transmission reservation.

Therefore, in the second embodiment, the control program further includes a reservation program. The reservation program is a program for repeatedly executing, while in the warning mode, the transmission of reservation commands to the mail server 14 and the transmission of release commands in response to the elapsing of the fifth predetermined time period, which is shorter than the fourth predetermined time period after which the email is transmitted.

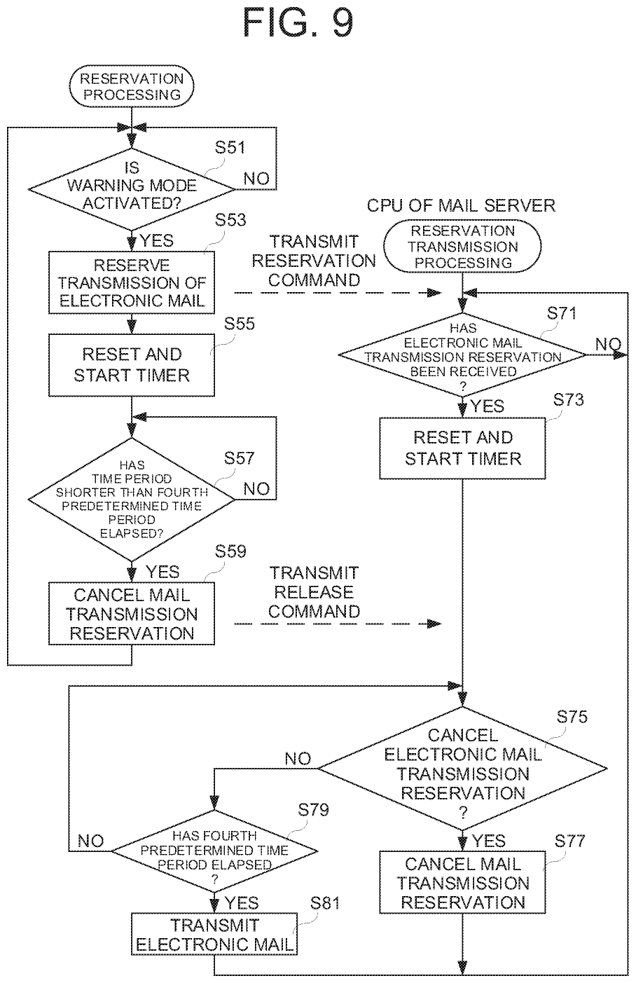

Specifically, the main CPU 22 executes the reservation processing flow shown in FIG. 9 in parallel with the control processing shown in FIG. 7 and FIG. 8. On the other hand, the CPU of the mail server 14 executes the reservation transmission processing flow shown in FIG. 9.

As shown in FIG. 9, when the main CPU 22 starts the reservation processing, it is determined in step S51 whether or not the current mode is the warning mode. If the result of step S51 is “NO”, that is to say, if the current mode is not the warning mode, the process returns to step S51. On the other hand, if the result of step S51 is “YES”, that is to say, if the current mode is the warning mode, a reservation command is transmitted to the mail server 14 in step S53 such that an email transmission is reserved.

A timer is reset and started in the following step S55. Although omitted in FIG. 6, the data storage area 404 is provided with a timer (counter), and this timer is reset and started in step S55. In the following step S57, it is determined whether or not the count value of the timer indicates that a time period shorter than the fourth predetermined time period has elapsed, that is to say, that the fifth predetermined time period has elapsed.

If the result of step S57 is “NO”, that is to say, if the count value of the timer indicates that the fifth predetermined time period has not elapsed, the process returns to step S57. On the other hand, if the result of step S57 is “YES”, that is to say, if the count value of the timer indicates that the fifth predetermined time period has elapsed, a release command is transmitted to the mail server 14 in step S59 such that the email transmission reservation is cancelled. Then, the process returns to step S51.

On the other hand, when the CPU of the mail server 14 starts reservation transmission processing, the CPU of the mail server 14 determines in step S71 whether or not an email transmission reservation has been received. That is to say, the CPU of the mail server 14 determines whether or not a reservation command from the image forming apparatus 12 has been received.

If the result of step S71 is “NO”, that is to say, if an email transmission reservation has not been received, the process returns to step S71. On the other hand, if the result of step S71 is “YES”, that is to say, if an email transmission reservation has been received, the timer is reset and started in step S73. The timer is provided in the RAM of the mail server.

Then, in step S75, it is determined whether or not the email transmission reservation is to be cancelled. That is to say, the CPU of the mail server 14 determines whether or not a release command has been received from the image forming apparatus 12. If the result of step S75 is “YES”, that is to say, if the email transmission reservation is to be cancelled, the email transmission reservation is cancelled in step S77. Then, the process returns to step S71.

On the other hand, if the result of step S75 is “NO”, that is to say, if the email transmission reservation is not to be cancelled, it is determined in step S79 whether or not the count value of the timer indicates that the fourth predetermined time period has elapsed.

If the result of step S79 is “NO”, that is to say, if count value of the timer indicates that the fourth predetermined time period has not elapsed, the process returns to step S75. On the other hand, if the result of step S79 is “YES”, that is to say, if the count value of the timer indicates that the fourth predetermined time period has elapsed, the reserved email addressed to an administrator is transmitted in step S81. Then, the process returns to step S71.

Similarly to the first embodiment, according to the first embodiment, it is possible to execute, while in the warning mode, alert processing that alerts that the commercial power supply 90 has been shut off, and alert processing that alerts that the network 16 has been shut off without providing a battery for issuing the alert.

Furthermore, according to the second embodiment, it is possible to transmit an email addressed to an administrator indicating that the network 16 has been shut off in the warning mode, even when the network 16 has been shut off. That is to say, it is possible to alert an administrator that the network 16 has been shut off.

The first embodiment and the second embodiment use a setting in which an email addressed to an administrator is transmitted. However, it is not necessarily limited to this. As another example, an email addressed to another specified person, such as a security personnel, may be transmitted.

Furthermore, the specific numerical values and the like presented in the embodiments above are examples, and can be appropriately changed in an actual product.

Further, the flow diagrams presented in the embodiments above are examples. The order of the steps can be arbitrarily changed if the same effects can be obtained.

### BRIEF DESCRIPTION OF THE REFERENCE SYMBOLS

10 Information processing system
12 Image forming device
14 Mail server
22 Main central processing unit (CPU)
24 random access memory (RAM)
26 Touch panel control circuit
28 Touch panel
30 Display control circuit
32 Display
34 Image forming unit
36 Image reader
38 Audio output unit
40 Human sensor
42 Wired communication unit
44 electrically erasable programmable read-only memory (EEPROM)
46 Power supply control CPU
48 Power supply control circuit
50 Power supply unit
52 Power button
70 Outlet plug
72 Main power supply switch
74 Resident power supply
76 Main power supply
78 Power button
90 Commercial power supply
92 Bridge diode
94, 102 Electrolytic capacitor
96, 108 Transformer
98 field effect transistor (FET)
100, 110 Diode
104, 106 Output terminal
112 full-wave (FW) signal generator

What is claimed is:

1. An image forming apparatus provided with a warning mode that, in response to detecting an intruder, alerts a surrounding person and/or a specified person that the intruder has been detected, the image forming apparatus including
a power supply determination device that determines whether or not a main power supply has been shut off when the mode is set, and
a first alert device that alerts the surrounding person and/or the specified person with a message indicating that the main power supply has been shut off, in response to the power supply determination device determining that the main power supply has been shut off.

2. The image forming apparatus according to claim 1, further including
a network determination device that determines whether or not a network has been shut off when the warming mode is set, and
a second alert device that alerts the surrounding person with a message indicating that the network has been shut off, in response to the network determination device determining that the network has been shut off.

3. The image forming apparatus according to claim 2, further including
a reservation execution device that transmits, while in the warning mode, a reservation command and to a mail server for reserving transmission of an email that includes a message indicating that the network has been shut off,
a reservation releasing device that transmits a release command to the mail server for releasing the reservation of the email transmission before a predetermined time period elapses following the transmission of the reservation command to the mail server by the reservation execution device, and
an execution device that causes repeated execution of the transmission of the reservation command by the reservation execution device and the transmission of the release command by the reservation releasing device.

4. A non-transitory computer-readable recording medium storing a control program executed by an image forming apparatus provided with a warning mode that, in response to detecting an intruder, alerts a surrounding person and/or a specified person that the intruder has been detected, the control program causing a processor of the image forming apparatus to execute:
determining whether or not a main power supply has been shut off when the warning mode is set, and
alerting the surrounding person and/or the specified person with a message indicating that the main power supply has been shut off, in response to determining that the main power supply has been shut off.

5. A control method of an image forming apparatus provided with a warning mode that, in response to detecting an intruder, alerts a surrounding person and/or a specified person that the intruder has been detected, the method including
(a) determining whether or not a main power supply has been shut off when the warning mode is set, and
(b) alerting the surrounding person and/or the specified person with a message indicating that the main power supply has been shut off, in response to determining in (a) that the main power supply has been shut off.
